(19) United States
(12) Patent Application Publication
(10) Pub. No.: US 2006/0051567 A1
(43) Pub. Date: Mar. 9, 2006

(54) Method for coating porous polyurethane resin

(76) Inventor: Koichi Ito, Kasugai-city (JP)

Correspondence Address: Kenneth F. Dusyn, 330 Main Street, Hartford, CT, 06106, US

(21) Appl. No.: 11/266,517

(22) Filed: Nov. 2, 2005

Related U.S. Application Data
(62) Division of application No. 10/671,860, filed on Sep. 25, 2003.

(51) Int. Cl. B32B 3/26; B01J 19/08; G21H 1/00; G21H 5/00; H01F 41/00

(52) U.S. Cl. 428/304.4; 427/457; 428/318.4

(57) ABSTRACT

A method for coating a porous polyurethane resin substrate with an aromatic isocyanate coating composition is provided comprising the steps of (i) providing a porous substrate of a polyurethane foam resin comprising at least one surface upon which the aromatic isocyanate coating composition is to be applied; (ii) applying at least one coating of a primary layer to the substrate surface, the primary layer comprising an aqueous solution of a compound that includes at least one —OH reactive group in its non-aqueous, dry state, and capable, upon drying, of forming a self-supporting, continuous film on the substrate surface at room temperature; (iii) optionally subjecting the applied primary layer to forced drying conditions at a temperature below the softening point of the porous polyurethane resin substrate; and (iv) after allowing the primary layer to substantially dry, applying a secondary layer comprising an aromatic isocyanate compound to the primary layer to form a continuous, film-forming coating on the substrate surface, preferably one having the property of being water-impermeable or water-impermeable and water vapor-permeable.

### FIELD OF THE INVENTION

The invention relates to a method for the application of an aromatic isocyanate coating to a porous polyurethane resin substrate, a method for preparing a porous polyurethane resin substrate to receive an aromatic isocyanate coating thereon, and the products obtained thereby.

### BACKGROUND OF THE INVENTION AND PRIOR ART

Polyurethane foam resins possess a resilient, sponge-like consistency, and therefore find extensive use in a wide variety of applications. Industries that utilize this particular foam resin include the automotive industry, for example on the dashboards and seats of automobiles; the packing industry for packaging in containers; household items, such as chairs, cushions, bedding and foundations for carpeting; safety protection, for example as liners in protective head gear; heat and sound insulation; and fibers and textiles to name a few. To render the foamed resin product suitable for its intended use, it is advantageous to provide the surface of the resin with a finished, sealed, protective layer or coating that has flexible and pliant characteristics consistent with the resilient nature of the polyurethane foam. The protective layer is especially important when visual aesthetics become a desirable feature for the end product and is generally accomplished by applying a film or coating of a polyurethane elastomer resin to the surface of the foamed resin product.

The foregoing films and coatings are readily available in the form of urethane paints, i.e., those containing at least one —NCO reactive group, because of the variety and function of finishes that they provide depending on the intended use of the foam product. However, when solvent-based urethane paints are used, they tend to erode the surfaces of the polyurethane foam product, and when aqueous or emulsion-based urethane paints are applied directly to the polyurethane foam product, they have a tendency to penetrate into the interior of the foam. In either case, the undesirable result is that the underlying foam substrate deteriorates causing the urethane paint-coated surface of the foamed resin to crack and/or become uneven. This presents an unsightly and uneven surface on the foam end-product, and eventually leads to a breakdown or failure of the foam product itself.

Various approaches have been taken for applying polyurethane films and coatings to a variety of polymer resin substrates utilizing the OH/NCO chemical bond relationship. Examples include compositions for coating hard plastic materials such as TPO (thermoplasic olefins) and RIM (reaction injected molding urethane) disclosed in U.S. Pat. No. 6,146,706; forming adhesive coatings on polyolefin substrates in U.S. Pat. No. 5,045,393; bonding dissimilar vinyl resin and polyurethane resin materials (U.S. Pat. No. 4,361,626); forming a coating on polyethylene or polypropylene substrates as disclosed in U.S. Pat. No. 4,567,106; forming aqueous two-component, polyurethane coating compositions as described in U.S. Pat. No. 6,180,180 B1; preparing slippery, adhering hydrogel coatings on polymeric plastic or rubber substrates in U.S. Pat. No. 5,662,960; forming a polyurea elastomer system on various kinds of substrates in U.S. Pat. No. 5,962,144; bonding a polyurethane surface to a polyvinyl chloride substrate as described in U.S. Pat. No. 6,048,619; and improving the bonding of a lubricious coating of, inter alia, polyurethane/polyethylene oxide or polyvinylpyrolidone to a substrate surface by the use of a functional tie layer applied to the substrate surface as disclosed in U.S. Pat. No. 6,270,902 B1.

Other approaches utilize aminosilane amines activated with alkanolamines for improving the adhesion of paint or thermosetting polymers to substrates such as glass and ceramics (described in U.S. Pat. No. 6,020,028), and forming water-proofing/sound proofing coatings on concrete surfaces which is described in U.S. Pat. No. 4,025,683.

In the foregoing approaches, the isocyanate compound is generally reacted with a hydroxyl-containing compound using various catalysts and/or curing conditions to effect the OH/NCO chemical bond for forming the desired coating on the substrate in question. The reactions generally involve detailed process conditions and specialized equipment to carry out the coating process. In the case of polyurethane paints, it is desirable to avoid pre-mixing the paint with a hydroxyl-containing compound before its application to the substrate in question because of economic and environmental considerations and because of chemical compatibility issues. It is also desirable to be able to apply a urethane paint, whether water or solvent-based and regardless of color, to a polyurethane foam substrate without having to prepare or process the paint for compatibility with the polyurethane foam substrate.

It is therefore an object of the invention to provide an efficient and cost effective method of providing a sealant and/or protective film coating for a polyurethane foam substrate to prevent penetration of an isocyanate-containing paint or topical coating formulation into the interior of the foam substrate when the paint or coating formulation is applied to the substrate. It is another object of the invention to provide a sealed surface layer for the polyurethane foam resin that is impervious to water, and also to provide a surface layer that is water-vapor permeable while at the same time being water impermeable. It is yet another object of the invention to provide a skin layer for the surface of the polyurethane foam resin that is continuous, durable, protective, compatibly resilient with the underlying polyurethane foam substrate, and aesthetically pleasing.

### SUMMARY OF THE INVENTION

The foregoing problems associated with the application of urethane paints to the surface of foamed or porous polyurethane resins are overcome by the methods according to the invention herein.

A method is provided for coating a porous polyurethane resin with an aromatic isocyanate coating composition. The method first comprises providing a porous substrate of a polyurethane resin comprising at least one surface upon which the isocyanate composition is to be applied. One or more applications of a primary layer is applied to the substrate surface, the primary layer comprising an aqueous solution of a compound that includes at least one —OH reactive group in its non-aqueous, dry state. The primary layer is one that is capable, upon drying, of forming a self-supporting, continuous film on the substrate surface at room temperature.

After allowing the primary layer to substantially dry, a secondary layer comprising an aromatic isocyanate coating composition, i.e., one that includes one or more reactive —NCO groups, is applied to the primary layer, which, when reacted with the primary layer, forms a continuous, protective, film-forming coating on the porous polyurethane resin, preferably one that possesses water-impermeable or water-impermeable/water vapor-permeable properties. By reacting the —NCO group(s) of the aromatic isocyanate composition compound with the —OH group in the primary layer, the protective film-forming coating on the porous polyurethane substrate is obtained.

In another aspect of the invention, a method for preparing a reactive film-forming surface on a porous polyurethane substrate for bonding with a coating composition comprising an aromatic isocyanate compound, is also provided. The method comprises the steps of providing a porous polyurethane substrate comprising a density of from about 0.002 to about 1.000 kilograms/cubic meter and at least one surface for preparing the reactive film-forming surface thereon. At least one layer of an aqueous solution of a compound containing at least one —OH radical group in the compound's non-aqueous, dry state is applied to the surface of the porous polyurethane substrate. The layer is capable, upon drying, of forming a self-supporting, continuous film on the substrate surface at room temperature.

In both of the foregoing methods, after the primary layer(s) is directly applied to the substrate surface, it may optionally be subjected to forced drying conditions below the softening temperature of the substrate, preferably at a temperature in the range of from 50° C. to 60° C., in order to accelerate the drying process.

Another embodiment of the invention includes a porous polyurethane product that is made according to the methods herein. The product comprises (i) a porous polyurethane resin substrate having a density of from 0.002 to 1.000 kilograms/cubic meter; and (ii) at least one coating of a primary layer disposed on at least one surface of the substrate. The primary layer comprises an aqueous solution of a compound that includes at least one —OH reactive group in its non-aqueous, dry state. The aqueous solution is capable, upon drying, of forming a self-supporting, continuous film on the substrate surface at room temperature. The product further comprises (iii) a secondary layer that is applied to and overlies the primary layer. In this case, the secondary layer comprises an aromatic isocyanate compound that includes at least one—NCO reactive group wherein the —NCO group of the secondary layer is reacted with the —OH group of the primary layer to form a continuous, film-forming coating on the substrate.

In yet another embodiment of the invention, a porous polyurethane product is provided which comprises a porous polyurethane resin substrate having a density of from about 0.002 to 1.000 kilograms/cubic meter; and (ii) a reactive film-forming layer disposed on at least one surface of the substrate for receiving thereon and reacting with one or more —NCO reactive groups of an aromatic isocyanate, film-forming compound. The film-forming layer comprises an aqueous solution of a compound that includes at least one —OH reactive group when it is in the non-aqueous, dry state. The film-forming layer must be capable, upon drying, of forming a self-supporting, continuous film on the surface pores of the substrate at room temperature.

In each of the methods and products described above, the preferred embodiments for the primary layer, i.e., the coating which is directly applied to and interfaces with the substrate surface, are generally the same. Thus, the primary layer may preferably include an aqueous solution of polyvinyl alcohol or polyvinyl alcohol/polyvinyl acetate copolymer, preferably in a concentration range of about 0.5 to 5 percent by weight, most preferably 3 to 4.5 percent. The polyvinyl acetate component of the copolymer is preferably present in an amount of 1-14 percent by weight, and most preferably in the range of 1-2 percent by weight. The primary layer may also include an aqueous solution of carboxymethylcellulose, preferably about 1 to 3 percent by weight, and most preferably 1.8 to 2.2 percent. Aqueous solutions of starch may also be used for the primary layer, preferably in a concentration range of about 1 to 8 percent by weight, and most preferably 3 to 5 percent. Aqueous gum arabic solutions are also included, preferably in the range of about 5 to 40 percent by weight and most preferably in the range of about 5 to 30 percent by weight.

Other preferred primary layer compounds include aqueous solutions of sodium or ammonium polyacrylate, preferably in the range of about 5 to 51 percent by weight, most preferably 20 to 41 percent, and preferably having a molecular weight range of from about 2,000 to 10,000; an aqueous solution of polyacrylic acid, preferably having a molecular weight range of from about 2,000 to 170,000 and preferably in the concentration range of about 5 to 41 percent by weight, most preferably 20 to 41 percent; an aqueous solution of sodium polycarboxylate, preferably in the range of about 10 to 41 percent by weight, most preferably 20 to 41 percent, and preferably having a molecular weight range of from about 2,000 to 170,000; and an aqueous solution of an alkyl acrylate or alkyl methacyrlate compound, preferably in the range of about 5 to 40 percent by weight, most preferably 10 to 20 percent, and preferably having a molecular weight range of from about 5,000 to 10,000.

As indicated above, any aromatic isocyanate coating composition that comprises at least one —NCO reactive group and which will form a continuous, film-forming resin structure on the substrate when reacted with the —OH group of the primary layer, without penetrating beyond the primary layer into the foam substrate, may be used as the secondary layer. The preferred class of coating compositions are those that comprise one or more aromatic isocyanate compounds which may be formulated as water- and solvent-based polyurethane paints. The aromatic isocyanate compound is preferably selected from the group consisting of 4,4′-diphenylmethane diisocyanate, 1,5-naphthalene diisocyanate, hexamethylene diisocyanate, toluene diisocyanate, 0-tolidine diisocyanate, xylylene disocyanate (XDI), hydro xylylene diisocyanate, and hydro 4,4′-diphenylmethane diisocyanate.

Additives may be included in the secondary layer particularly when the secondary layer is in the form of a water- or solvent-based paint. For example, the secondary layer may additionally comprises an anti-hydrolysis agent, such as a polycarbodiimide, and/or a weather-resistance agent, such as {tetrakis [methylene-3-(3′5′-ditert-butyl-4′-hydroxylphenyl) propionate]methane}.

### DETAILED DESCRIPTION OF THE INVENTION

Protective coatings in the form of solvent- or emulsion-containing aromatic isocyanate compounds, i.e., paint formulations containing at least one —NCO group such as exists in polyurethane paints and coatings, are generally applied to at least one surface of a resilient polyurethane foam stock or substrate for enabling their use in a variety of applications requiring an effective seal or protective film layer. Applications include the automotive industry wherein polyurethane foams are used for cushions, padding and the like; consumer oriented applications that include chair cushions, bedding and head protective gear; floor padding for carpeting; heat, sound and water insulation; adhesives and binders; etc. In order to prevent damage to the broad variety of substrates, or simply to obtain adhesion to a given substrate, various polymers possessing film-forming capabilities have been added to and reacted with the urethane coatings themselves. Unfortunately, depending on the kind of substrate that is being coated, compatibility issues arise when formulating the film-forming polymer with a given urethane coating thereby restricting the availability of the urethane coating that can be used for a given substrate.

The present invention overcomes this problem for polyurethane foam resin substrates with the discovery that certain film forming, hydroxyl-containing compounds containing an active —OH group in the dry, non-aqueous state, will continue to react and bond with the —NCO group of an aromatic isocyanate coating or film-forming compound to form an effective coating or film for the polyurethane foam substrate. The invention therefore enables the application of a urethane resin, whether water- or solvent-based, to the pre-treated polyurethane foam substrate without the necessity of pre-mixing and reacting the hydroxyl-containing compound with the urethane resin coating. The result is that the hydroxyl-containing compound does not have to be pre-mixed with the resin in order to obtain an effective bond between the urethane resin and the polyurethane foam substrate.

Therefore, in accordance with the invention, a method is provided for applying an aromatic isocyanate coating compound to the surface of a polyurethane foam resin without the problems associated with seepage into the interior of the foam, and/or chemical attack of the foam by the isocyanate coating compound.

The first step of the method is to provide a surface of a polyurethane foam substrate upon which the aromatic isocyanate coating compound is to be applied. Polyurethane foam is generally produced by mixing a polyol with a diisocyanate compound, water stabilizers, and a suitable catalyst. The chemical reaction that takes place
R—N═CO+H₂O→RNHCO—OH
releases carbon dioxide and is exothermic which causes the reactants to expand into a foam. Various densities of foam can be produced depending on the end use for the foam in question. The density of the foam is generally controlled by the amount of water that is added to the reaction mixture. The foam produced can be carried out continuously on a channel shaped conveyor or may be produced from a static mold.

The polyurethane foam stock that is produced may, according to the invention herein, be classified according to its density, that is, the resilient foam material may be of a high, medium or low density, which for the purposes of this invention and practical end-use applications, can be anywhere between 0.002 and 1.000 kilograms/cubic meter. The high density foam resin is one which may be regarded as being above 0.050 kilograms/cubic meter; the medium density foam between 0.020 kilograms/cubic meter and 0.050 kilograms/cubic meter; and the low density foam being less than 0.020 kilograms/cubic meter. The intended or end-use of the polyurethane foam substrate will generally dictate the foam's density.

The second step is the application of an aqueous solution or aqueous slurry of the primary layer to the surface of the polyurethane foam substrate. The primary layer that is suitable for forming an intermediate film on the polyurethane foam surface comprises a compound that includes at least one hydroxyl group, preferably more than one, in the polymer chain when it is in the non-aqueous, dry state, and is capable, upon drying, of forming a continuous, self-supporting film on the surface of the foam substrate, preferably at room temperature. The primary layer that is formed on the polyurethane foam substrate is one that preferably lends itself for adherence and/or adhesion to the surface of the foam substrate, is preferably pliable with the resilient nature of the foam, resists substantial penetration into the interior of the foam surface, resists cracking, and has good water-resistance properties when dry, i.e., is substantially water-impervious upon drying. Adherence of the primary layer to the polyurethane foam substrate is due to the primary layer's penetration into the surface pores of the substrate followed by the drying of the aqueous solution of the primary layer. A flexible mechanical bond is therefore formed between the substrate and the primary layer. Moreover, any adhesive properties possessed by the primary layer will assist and add to its adherence to the substrate surface.

Suitable components that are representative for the primary layer include polyvinyl alcohol and its derivatives, polyvinyl alcohol/polyvinyl acetate copolymers, water soluble, film-forming polymers formed from carboxylates, acrylates and methacrylates, such as the alkyl acrylates and alkyl methacrylates, and cellulose derivatives, for example, carboxymethylcellulose, starch, gelatin, gum arabic and/or mixtures thereof.

The primary layer may be applied to the surface of the polyurethane foam by any known or conventional technique, for example by mechanical spraying, or manually through the use of a brush, spatula or knife. The choice of technique will be largely dependant on the viscosity of the primary layer solution or slurry to be applied. Mechanical spraying techniques may be used when the viscosity of the primary layer solution does not exceed 15 centipoise. Beyond this value, it is generally acceptable to employ alternative application techniques, for example, by other conventional mechanical means or by manual application.

The choice of viscosity of the primary layer solution for applying and forming a continuous self-supporting film on the surface of a polyurethane foam substrate is important and will largely depend on the density and end use of the substrate in question and the concentration of the primary layer compound in solution. The viscosity of a given primary layer compound solution will be determined by the compound's aqueous concentration, and it will be appreciated that this will vary for each primary layer compound. Therefore, it will be appreciated that a wide concentration range for the primary layer is available for practicing the methods according to the invention herein. Generally, the aqueous concentration of the primary layer compound will be in a wide range of from about 0.2 to 51 percent by weight.

More specifically, low density polyurethane foams, i.e., foams having a density of less than 0.020 kilograms/cubic meter as defined according to the invention herein, will require a solution having a relatively higher viscosity value, usually above 10 centipoise, although multiple applications, e.g., as many as three or more applications, may be used to obtain a sufficient self-supporting film on the foam surface, especially if the viscosity of the aqueous solution is relatively low for the foam in question. For practical considerations, the economy of the invention is optimized when three or less applications are utilized. For medium density polyurethane foams, i.e., those between 0.020 and 0.050 kilograms/cubic meter, the viscosity of the solution will generally be above 5 centipoise, and depending on the concentration of the solution, up to three applications may be used to secure a continuous film on the foam substrate surface. Higher density polyurethane foams with a density of greater than 0.050 kilograms/cubic meter will, depending on the end use, generally require only one application if the solution viscosity is about 1 to 5 centipoise, although multiple applications may be used if the viscosity is relatively low for a given aqueous solution. When mixtures of different primary layer compounds are employed, the viscosity of the final solution can be adjusted according to the density of the polyurethane foam substrate.

The primary layer compound of choice is polyvinyl alcohol (PVA) or polyvinyl alcohol/polyvinyl acetate copolymer (PVA/PVAct). In the case of PVA/PVAct, the polyvinyl acetate component is present in an amount of about 1-14 percent by weight, preferably 1-2 weight percent. The production of PVA/PVAct is well known in the art, and is made by hydrolyzing polyvinyl acetate which is obtained through the polymerization of vinyl acetate monomer. By diversifying the degree of polymerization and hydrolization, various grades of PVA/PVAct can be produced which in turn will provide varying ranges of viscosity when an aqueous solution is formed. When applied to the polyurethane foam substrate, the preferred aqueous concentration of the PVA or PVA/PVAct copolymer is generally in the range of from about 0.5 to about 5 percent by weight, with from about 3 to about 4.5 percent by weight being most preferred. The final concentration selection (and thus the viscosity) will be adjusted for the foam's density, i.e., whether it is high, medium or low density. PVA and PVA/PVAct copolymer is a generally available compound, and may be obtained from Japan Vam & Poval Co., Ltd. in the Osaka coastal industrial region under the tradename of “J Poval.” Their grades, types and properties are set forth in their 03/04/10 publication.

Aqueous solutions of film-forming polymers derived from carboxylates, acrylates, and methacrylates, may also be used with effectiveness as the primary layer. When applied to the polyurethane foam substrate, the preferred aqueous concentration of these compounds will generally range from about 0.2 to about 51 percent by weight, preferably 20 to 40 weight percent. The choice of concentration (and final viscosity) of the primary layer will ultimately depend on the polyurethane foam's density for forming a self supporting, continuous film thereon. The acrylates include the alkyl acrylates, such as methyl- and ethyl-acrylate, n-butyl acrylate and 2-ethylhexyl acrylate, while the methacrylates include the alkyl methacrylates such as methy-, ethyl-, isobutyl-, n-butyl and 2-ethylhexyl-methacrylate.

Representative examples of film-forming polymers also include sodium polycarboxylate, sodium or ammonium polyacrylate, and polyacrylic acid, having a molecular weight range of from about 2,000 to about 170,000. The sodium polycarboxylate concentration will preferably be in the range of about 10 to 41 percent by weight, most preferably 20 to 41 percent if only one coating is applied to the polyurethane foam substrate. The sodium polycarboxylate preferably has a molecular weight range of from about 2,000 to 170,000.

The aqueous concentration of the sodium or ammonium polyacrylate will preferably be in the range of about 10 to 51 percent by weight, most preferably 20 to 41 percent if only one coating is applied to the foam substrate. The sodium or ammonium polyacrylate preferably has a molecular weight range of from about 2,000 to 10,000.

The aqueous concentration of polyacrylic acid will preferably be in the range of about 5 to 41 percent by weight, with 20 to 41 percent being most preferred if a single coat is applied to the substrate. The polyacrylic acid preferably has a molecular weight range of from about 2,000 to 170,000. Polysulfonic acid and sodium polysulfonate aqueous solutions may also be used. The preferred concentration of the polysulfonic acid is about 2 to about 20 percent by weight, while the prefered concentration of the sodium polysulfonate is about 0.2 to 20 percent by weight. The molecular weight range is preferably about 8,000 to 12,000. The above compounds are readily available from Toa Gosei Company, Ltd., Japan, under their ARON brand of products. The glycols, such as ethylene, propylene and butylene glycol, as well as glycerol, may also be used with some effectiveness on high or medium density polyurethane foam substrates but not on low density polyurethane foam substrates owing to their relatively low viscosity.

Another class of compounds that are useful as the primary layer on the polyurethane foam substrate are the cellulose derivatives, representative examples of which include carboxymethylcellulose (CMC), various kinds of starch (e.g., corn, potato, rice, tapioca, wheat, etc.) gelatins (e.g., agar-agar) and gum arabic. Once again, the aqueous concentrations, and hence the viscosities, of these compounds are adjusted according to the density of the polyurethane foam substrate. For example, the aqueous concentration range for CMC will generally be from about 1 percent to about 3 percent with 1.8 to 2.2 percent being preferred; for starch, such as potato starch, from about 1 percent to about 8 percent, with 3 to 5 percent being preferred; and for gum arabic, from about 5 percent to about 40 percent, with 5 to 30 percent being preferred; the percentages being expressed by weight.

Once the primary layer is applied to the surface of the polyurethane foam substrate, it is allowed to dry. One of the advantages of using the primary layer compounds according to the invention is that drying may be effected at room temperature, thereby providing an economic benefit in that further process conditions and equipment, such as that required for curing or additional chemical treatment, are eliminated. It will be understood, however, that the drying process can be enhanced by optionally subjecting the coated foam substrate to forced drying conditions at a temperature range of from 50° C. to 60° C. However, care must be taken not to have the drying temperature exceed the softening temperature of the polyurethane foam which is about 80° C. The extent of drying should be substantially complete so as to avoid the formation of blisters or bubbles in the film layer after the polyurethane paint is applied to the primary layer.

After the primary layer is allowed to substantially dry, a foamed polyurethane resin product is obtained which enables the application of an aromatic isocyanate coating composition thereon at any point in time subsequent to its preparation. The prepared polyurethane foam product need not be immediately coated owing to the presence of the reactive hydroxyl group(s) that is present in the primary layer's dry state. The added benefit is that it lends chemical functionality to the prepared foam substrate after the primary layer is dried. The primary layer compound is sufficiently stable so as not to be influenced or altered if left as it is for a long period of time after drying. Because of the “stored chemical functionality” of the primary coated foam substrate according to the invention, an aromatic isocyanate coating composition, i.e., one that includes one or more aromatic isocyanate compounds having at least one —NCO radical, can be applied to the primary layer at any point in time. The —NCO radical(s) of the aromatic isocyanate coating composition will thereby cross-link with the primary layer's hydroxyl group(s) to form a chemical bond between the two layers for producing a smooth, flexible, continuous film or coating. As a result, the prepared polyurethane foam product is able to receive a future application of, for example, a polyurethane resin paint possessing any number of the qualities set forth below that will characterize the final film layer formed on the foam substrate.

Of particular usefulness for preparing a finished foam resin product that is protected with a durable, flexible resin coating, is the application of an aromatic isocyanate topcoat, or a secondary layer, to the primary layer of the prepared foam substrate. The secondary layer coatings that have enhanced utility for the polyurethane foam substrates are the polyurethane resin paints which have been developed and made available in a wide range of properties and characteristics to satisfy a desired surface or finish for the continuous film formed on the polyurethane foam substrate. Among the properties that are available for the topcoat are those polyurethane paints that provide a smooth surface finish, transparency, hot and cold water resistance, water-impermeability/water vapor-permeability, weather and heat resistance, solvent and chemical resistance, hydrolysis resistance, hard and soft films, safety with respect to health and environment when used with textiles and consumer-oriented products, translucency, wet and dry lamination suitability, to describe but a few. Excluded from the invention are those isocyanate coating compounds that require curing or processing at temperatures which exceed the softening point of the polyurethane foam for adhering with a given substrate.

Representative examples of compounds that form a basis as the secondary layer for application to and reaction with the primary coated polyurethane foam substrate, are those aromatic isocyanate compounds containing one or more —NCO reactive groups, which include the diisocyanate compounds, such as

Diphenyl diisocyanate,

4,4′-Diphenylmethane diisocyanate (MDI),

1,5-Naphthalene diisocyanate,

Hexamethylene diisocyanate,

Hexamethylene-1,6-diisocyanate,

Tolylene diisocyanate (TDI),

2,4-Tolylene diisocyanate and 2,6-tolylene diisocyanate,

0-Tolidine diisocyanate,

Tetramethylxylylene diisocyanate,

4,4-Methylene-bis(cyclohexyl diisocyanate),

Trimer of hexamethylene diisocyanate,

Dimer acid diisocyanate,

Isophorone diisocyanate,

Dicyclohexylmethane 2,4′-diisocyanate and dicyclohexylmethane

4,4′-Diisocyanate,

Xylylene disocyanate (XDI),

Hydro Xylylene diisocyanate (H₆XDI), and

Hydro 4,4′-diphenylmethane diisocyanate (H₁₂MDI).

The aromatic isocyanate compound is preferably selected from the group consisting of 4,4′-diphenylmethane diisocyanate, 1,5-naphthalene diisocyanate, hexamethylene diisocyanate, toluene diisocyanate, 0-tolidine diisocyanate, xylylene disocyanate (XDI), hydro xylylene diisocyanate, and hydro 4,4′-diphenylmethane diisocyanate

While other forms are possible, the topcoat or secondary layer polyurethane resins will typically take the form of a water-based or solvent-based paint which, as known in the art, e.g., U.S. Pat. No. 4,025,683, U.S. Pat. No. 4,361,626, U.S. Pat. No. 6,048,619, U.S. Pat. No. 6,180,180 B1, U.S. Pat. No. 6,428,856 B1, are obtained by reacting one or more of the diisocyanate compounds with an appropriate polyol, e.g., polyoxypropylene glycol, and optionally, one or more additives such as catalysts, thickeners, flow control agents, pigments, fillers, biocides, emulsifiers, antioxidants, ultraviolet light absorbers, and the like, to obtain a particular chemical or physical property for the polyurethane resin.

In addition, an anti-hydrolysis agent, such as a polycarbodiimide, may be added to the NCO-containing resin. Organic carbodiimides are generally known in the art. Their chemistry is described, for example, in Chemical Reviews, Vol. 53 (1953), pages 145 to 166, and Angewandte Chemie 74 (1962), pages 801 to 806. Polycarbodiimides can be prepared, for example, by treating sterically hindered polyisocyanates with basic catalysts with the elimination of carbon dioxide. A detailed discussion of the polycarbodiimides is contained in U.S. Pat. No. 5,504,241 issued on Apr. 2, 1996. Examples of the polycarbodiimides include XL29SE made by UCC, Carbodilite E-01 (nonvolatile solid content: 40%) made by Nisshinbo Co., Ltd., and aromatic carbodiimides made by Rhein-Chemie under the name Stabaxol.RTM.P200.

The additives are generally present in the total resin mixture in an amount of from about 0.1 to 1.0 percent by weight.

Other additives for incorporation with the NCO-containing resin formulation may include about 1500 ppm of a weather-resistance agent such as {tetrakis [methylene-3-(3′5′-ditert-butyl-4′-hydroxylphenyl) propionate]methane} available from the Ciba Geigy Company under the trade name Iruganox 1010.

The secondary layer, aromatic isocyanate resin formulations that are in the form of water- or solvent-based paints are readily available from a number of manufacturers. As water-based polyurethane resin paints, those available from Dai-ichi Kogyo Sieyaku Company, Ltd., Kyoto, Japan, under the SUPERFLEX®, SUPERFLEX® E, SUPERFLEX® R, ELASTRON and ELASTRON BN series of paints find particular beneficial application for bonding with the primary layer to produce a film-forming finish to the polyurethane product possessing any number of the properties enumerated above. In particular the SUPERFLEX® E-2000 and E-2500 brands possess the added property of being water-impermeable while simultaneously being water-vapor permeable. This property provides the polyurethane foam product with a resistance to the penetration of water into the interior of the foam substrate but allows the product to “breathe.” That is to say, the finished coating formed on the polyurethane foam substrate permits water vapor or moisture in the air to transpire to either side of the foam product while simultaneously blocking the seepage of water from the exterior of the coating into the interior of the foam substrate. These paints and their respective properties are set forth in their booklet entitled “Water-Dispersed Polyurethane SUPERFLEX®.” Other water-based polyurethane resin paints are available under the tradename TAKENATE WD-220 from Mitsui Takeda Chemicals, Inc., Tokyo, Japan.

Solvent-based polyurethane resin paints are available from manufacturers that include Mitsui Takeda Chemicals, Inc., Tokyo, Japan, under their TAKENATO “D” line of resins classified as “general-purpose type,” “quick-drying type” and “non-yellowing type,” e.g., their D-101A, D-102 and D-103 brands which are based on a formulation using a mixture of polyoxypropylene glycol, tolylene diisocyanate, and diphenylmethane-4-4′-diisocyanate. Their “Specifications List” contains an itemization and description of their polyurethane resins. They are also available from C. L. Hauthaway & Sons Corporation of Lynn, Mass., U.S.A. whose water-borne polyurethane resins are available under their HAUTHANE “HD-” line of paints identified in their various brochures and literature, specifically their “Hauthaway Coatings Resins” brochure.

As indicated hereinbefore, the common characteristics of the secondary layer polyurethane resins that are preferred for reacting with the primary layer to form a well-bonded, continuous film on the foam substrate, whether pigmented or clear, is that (i) they possess one or more —NCO radicals in their molecular structure, (ii) can be applied to the primary layer at room temperature without penetration beyond the primary layer into the interior of the foam substrate, and (iii) possess a viscosity of about 2 cps to about 6 cps at 25° C. The resulting high-bonding strength of the continuous film formed with the primary layer is accompanied by a strong resistance to becoming separated from the foam substrate which, according to the invention, is accomplished with a minimization of equipment and process conditions.

The aromatic isocyanate resins according to the invention, specifically those that are formulated in the form of polyurethane paints, are applied to the primary layer by any conventional technique, e.g., by mechanical spraying or by manual application with a brush. A relatively thin coat is used to effect the bonding process with the primary layer and is also used to facilitate the rise to the surface of any bubbles that may be formed during the coating process. Therefore, the resin is generally applied with a thickness of from about 0.01 to about 0.30 centimeters, preferably from about 0.05 to about 0.10 centimeters. More than one coat of the resin may be used if circumstances warrant, e.g., if a low density polyurethane foam is being used in which case a second and third coat may be applied each with a preferable thickness of from about 0.05 to about 0.10 centimeters. After each application of the polyurethane resin, it is allowed to dry at room temperature, or if time is a factor, the coated foam substrate product may be force dried at a temperature range of from about 50° C. to about 60° C.

Throughout the following description, the invention is illustrated in greater detail by means of exemplary embodiments which are intended as examples rather than limitations on the methods and products according to the invention herein. All parts and concentrations are by weight unless expressly stated otherwise.

### EXAMPLE 1

A water-based, ester type, polyurethane paint, available from Dai-ichi Kogyo Sieyaku Company, Ltd., Kyoto, Japan, under the tradename Superflex® E-4500, and having a pH range of 6 to 8, was applied to a horizontally displaced surface of a 7 cm. thick, high-density polyurethane foam resin substrate having a density of 55 kg/m³. After 90 minutes, the paint was observed to penetrate into the interior of the foam resin substrate by an amount of 0.15 cm.

### EXAMPLE 2

A solvent-based, red aromatic isocyanate paint, available from Mitsui-Takeda Seiyaku Company, Ltd., of Tokyo, Japan, under the tradename designation D-101A, was applied by a spray gun to a horizontally displaced surface of a 0.05 kg/m³ density polyurethane foam resin substrate. After 2 to 3 minutes, the foam having direct contact with the solvent-based paint was visually observed to physically deteriorate. The foam consistency became separated, and after drying, crumbled when physical contact was made with the affected portions of the substrate.

### EXAMPLE 3

A 10% aqueous solution of polyvinyl alcohol/polyvinyl acetate copolymer (PVA/PVAc)for providing a coating on a polyurethane foam resin substrate having a high density 0.55 kg/m³ was prepared as follows. Ten grams of PVA/PVAc copolymer granules, available under the tradename JF-05 manufactured by Japan Vam & Poval Co., Ltd., Japan, and having a molecular weight range of from 490 to 510, was mixed with 100 ml of water and steam heated to a temperature of between 85° C. to 100° C., while stirring, to obtain an aqueous solution having a viscosity of 7 centipoise. The viscosity of the solution at room temperature was measured using a Rion “Viscotester” apparatus, Model T-04. The viscosity of the PVA/PVAct can be adjusted from 4 centipoise to 45 centipoise by adjusting the aqueous concentration of the PVA/PVAct solution.

Once the desired consistency of the PVA/PVAct solution was obtained, it was applied to a surface of a horizontally displaced polyurethane foam resin using a spray gun under ambient conditions, and allowed to dry. A continuous, self-supporting skin layer of PVA/PVAct copolymer containing hydroxyl groups was formed on the surface pores of the polyurethane foam. The skin layer had a flexibility consistent with the resilient nature of the foam substrate, and was smooth and continuous. No substantial penetration of the PVA/PVAct solution into the interior of the foam substrate was observed.

After the coated polyurethane foam resin is prepared, a water-based polyurethane paint, available from Dai-ichi Kogyo Sieyaku Company, Ltd., Kyoto, Japan, under the tradename Super Flex 820, is applied to the coated surface of the polyurethane foam resin. The painted surface bonded to the foam substrate well, had a natural opaque color, good flexibility and appearance, and has the properties of being water- and weather-resistant. No paint was observed to penetrate into the interior of the polyurethane foam substrate.

### EXAMPLES 4-5

A 5% and 20% aqueous solution of a PVA/PVAct copolymer was prepared as Examples 4 and 5, respectively, in the same manner as set forth in Example 3. The PVA/PVAct granules used were also those available under the tradename JF-05 manufactured by Japan Vam & Poval Co., Ltd., Japan, and having a molecular weight range of from 490 to 510. The viscosity of each solution was determined to be 4 centipoise for the 5% solution and 45 centipoise for the 20% solution. One coating of the 5% and 20% PVA/PVAct solutions, as well as the 10% PVA/PVAct solution of Example 3, was then applied to the surfaces of four polyurethane foam substrates (“PUFS”), each having a different density of 0.016 kg/m³, 0.021 kg/m³, 0.026 kg/m³, and 0.055 kg/m³. After their application, the treated polyurethane foam substrates were allowed to dry at room temperature. The results are provided in Table A.

TABLE A

| PUFS | Example 4 | Example 3 | Example 5 |
|---|---|---|---|
| Density | 5 wt. % Soln. | 10 wt. % Soln. | 20 wt. % Soln. |
| (kg/m³) | (4 cps) | (7 cps) | (45 cps) |
| 0.016 | X | ◯ | ◯ |
| 0.021 | Δ | ◯ | ◯ |
| 0.026 | Δ | ◯ | ◯ |
| 0.055 | ◯ | ◯ | ◯ |

Key:
X Continuous film not formed.
Δ Weakly formed film.
◯ Good continuous film.

Owing to the spacious porosity of the 0.016 kg/m ³ density PUFS, a continuous, self-supporting film could not be formed over the entire surface of the foam substrate using the 5 weight percent solution of PVA/PVAct. The 5% PVA/PVAct solution on the 0.021 kg/m³ and 0.026 kg/m³ samples of PUFS showed a scattered formation of film on the substrate surface having a thickness of a few microns, thereby classifying it as “a weakly formed film.” The remainder of the PVA/PVAct solutions demonstrated the formation of a good, self-supporting, continuous film on the PUFS surface without substantial penetration into the interior of the substrate.

After the PUFS samples in Table A were allowed to dry, the treated substrates that resulted in having a “good continuous film” were manually coated with various polyurethane resin paints using a brush. The polyurethane resins used were both water- and solvent-based paints available from Dai-ichi Kogyo Sieyaku Company, Ltd., Kyoto, Japan, and Mitsui Takeda Chemicals, Inc., Tokyo, Japan, respectively. The water-based polyurethane paints used from Dai-ichi Kogyo Sieyaku Company, Ltd. were SUPERFLEX® E-4500, SUPERFLEX® E-2000 and SUPERFLEX® E-2500. The paints used from Mitsui Chemical, Inc. were the general-purpose type paints under the trade designations of Takenato WD-220 (water-based), D-101A (solvent-based), and D-102 (solvent-based). When applied to each of the PUFS samples set forth in Table A (with the exception of those designated as “Δ” and “X”) and allowed to dry at room temperature, a protective, self-supporting, continuous film was formed on the polyurethane foam substrate which strongly adhered to the substrate's surface. In addition, no deterioration of the foam substrate or penetration into its interior by the polyurethane paints was observed. Furthermore, urethane bonding was made complete by chemical reaction between the —NCO group and the —OH group, and the film layer formed on each of the PUFS samples was smooth and continuous, and possessed the degree of flexibility consistent with the resilient nature of the foam substrate. Moreover, the PUFS coated with the SUPERFLEX E-2000 and E-2500 polyurethane paints were observed to possess the property of being water impermeable while simultaneously being permeable to water vapor.

### EXAMPLES 6-8

As Example 6, a 1% aqueous carboxymethylcellulose (“CMC”) solution was prepared by dissolving 1 gram of carboxymethylcellulose powder, available from Daicell Kagaku Kougyo Co., Ltd. under the brand name CMC-1105, in 99.0 grams of water. The viscosity of the milky white solution was determined to be 10 centipoise at room temperature using a Rion “Viscotester” apparatus, Model T-04.

As Example 7, a 1.5% aqueous CMC solution was prepared in a similar manner as Example 6 by dissolving 1.5 grams of the same CMC powder in 98.5 grams of water. The viscosity of the solution was determined to be 80 cps.

For Example 8, a 2% aqueous CMC solution was prepared in similar fashion to Example 6 by dissolving 2.0 grams of the same CMC powder in 98.0 grams of water. The viscosity of the solution was determined to be 150 cps.

One coating of each of the CMC solutions of Examples 6-8 were manually applied with a brush to the surface of high, medium and low density polyurethane foam substrates (PUFS) to form a film thereon, and allowed to dry at room temperature. The densities of the foam substrates were the same as those used in Table A, i.e., 0.016, 0.021, 0.026 and 0.055 kg/m³. The result of the prepared PUFS are presented in Table B.

TABLE B

| PUFS | Example 6 | Example 7 | Example 8 |
|---|---|---|---|
| Density | 1% CMC Soln. | 1.5% CMC Soln. | 2.0% CMC Soln. |
| (kg/m³) | (10 cps) | (80 cps) | (150 cps) |
| 0.016 | ◯ | ◯ | ◯ |
| 0.021 | ◯ | ◯ | ◯ |
| 0.026 | ◯ | ◯ | ◯ |
| 0.055 | ◯ | ◯ | ◯ |

Key:
X Continuous film not formed.
Δ Weakly formed film.
◯ Good continuous film.

After the PUFS samples in Table B were allowed to dry, they were manually coated with various polyurethane resin paints using a brush to form a film thereon. The polyurethane resins used were both water- and solvent-based paints available from Dai-ichi Kogyo Sieyaku Company, Ltd., Kyoto, Japan, and Mitsui Takeda Chemicals, Inc., Tokyo, Japan. The water-based polyurethane paints used from Dai-ichi Kogyo Sieyaku Company, Ltd. were SUPERFLEX® E-4500, SUPERFLEX® E-2000 and SUPERFLEX® E-2500. The paints used from Mitsui Chemical, Inc. were the solvent-based paints under the trade designations of Takenato D-101A, D-102, and D-103.

When applied to each of the PUFS samples set forth in Table B and allowed to dry at room temperature, a protective, self-supporting, continuous film was formed on the polyurethane foam substrate which strongly adhered to the substrate's surface. In addition, no deterioration of the foam substrate or penetration into its interior by the polyurethane paints was observed. Furthermore, urethane bonding was accomplished by chemical reaction between the —NCO group of the paint layer and the —OH group in the primary layer, and the resulting film layer formed on each of the PUFS samples was smooth and continuous, and possessed the degree of flexibility consistent with the resilient nature of the foam substrate. Moreover, the PUFS coated with the SUPERFLEX E-2000 and E-2500 polyurethane paints were observed to possess the property of being water impermeable while simultaneously being permeable to water vapor.

### EXAMPLES 9-11

A liquid solution of sodium polyacrylate available under the trade name ARON A-10SL from Toa Gousei Company, Ltd., Japan, and having a molecular weight of approximately 6,000 and a viscosity of 20 cps, was used by itself (100 parts sodium polyacrylate and 0 parts water), as Example 9, for manual application to the various PUFS identified in Table A.

For Example 10, a solution of 100 parts of the liquid polyacrylate of Example 9 and 50 parts of water was prepared, and the viscosity of the solution was determined to be 3 cps.

As Example 11, a solution of 100 parts of the liquid polyacrylate of Example 9 and 100 parts of water was prepared whose viscosity was determined to be 1 cps.

A single coating of each of the polyacrylate solutions of Examples 9-11 were manually applied with a brush to the surface of polyurethane foam substrates (PUFS) whose densities are identical to those set forth in Table A. A thin film was formed on the surface of each PUFS and allowed to dry at room temperature. The results of the prepared PUFS are presented in Table C.

TABLE C

| PUFS | | | |
|---|---|---|---|
| Density | Example 9 | Example 10 | Example 11 |
| (kg/m³) | (20 cps) | (3 cps) | (1 cps) |
| 0.016 | ◯ | ◯ | Δ |
| 0.021 | ◯ | ◯ | ◯ |
| 0.026 | ◯ | ◯ | ◯ |
| 0.055 | ◯ | ◯ | ◯ |

Key:
X Continuous film not formed.
Δ Weakly formed film.
◯ Good continuous film.

After the PUFS samples in Table C were allowed to dry, they were manually coated with various polyurethane resin paints using a brush to form a film thereon. The polyurethane resins used were both water- and solvent-based paints available from Dai-ichi Kogyo Sieyaku Company, Ltd., Kyoto, Japan, and Mitsui Takeda Chemicals, Inc., Tokyo, Japan, respectively. The water-based polyurethane paints used from Dai-ichi Kogyo Sieyaku Company, Ltd. were SUPERFLEX® E-4500, SUPERFLEX® E-2000 and SUPERFLEX® E-2500. The paints used from Mitsui Chemical, Inc. were the solvent-based paints under the trade designations of Takenato D-101A, D-102, and D-103.

When applied to each of the PUFS samples set forth in Table C and allowed to dry at room temperature, a protective, self-supporting, continuous film was formed on the polyurethane foam substrate which strongly adhered to the substrate's surface. In addition, no deterioration of the foam substrate or penetration into its interior by the polyurethane paints was observed. Furthermore, urethane bonding was made complete by chemical reaction between the —NCO group and the —OH group, and the film layer formed on each of the PUFS samples was smooth and continuous, and possessed the degree of flexibility consistent with the resilient nature of the foam substrate. Moreover, the PUFS coated with the SUPERFLEX E-2000 and E-2500 polyurethane paints were observed to possess the property of being water impermeable while simultaneously being permeable to water vapor.

### EXAMPLES 12-14

As Example 12, a liquid solution of methyl methacrylate copolymer available under the trade name LIPOTEX m-400 from Lion Company, Ltd., Japan, and having a molecular weight of approximately 1,000 and a viscosity of 5 cps, was used by itself (100 parts methyl methacrylate and 0 parts water) for manual application to the PUFS of different densities identified in Table A.

For Example 13, a solution of 100 parts of the liquid methyl methacrylate of Example 12 and 50 parts of water was prepared. The viscosity of the solution was determined to be 3 cps.

As Example 14, a solution of 100 parts of the liquid methyl methacrylate of Example 12 and 100 parts of water was prepared. However, the viscosity of this mixture could not be measured because of being too low for the Rion “Viscotester” apparatus.

One coating of each of the methyl methacrylate solutions of Examples 12-14 were manually applied with a brush to the surface of polyurethane foam substrates (PUFS) whose densities are identical to those set forth in Table A. With the exceptions noted in Table D, a thin film was formed on the surface of the PUFS and allowed to dry at room temperature. The results of the prepared PUFS are presented in Table D.

TABLE D

| PUFS | | | Example 14 |
|---|---|---|---|
| Density | Example 12 | Example 13 | (Viscosity |
| (kg/m³) | (5 cps) | (3 cps) | too low) |
| 0.016 | ◯ | ◯ | ◯ |
| 0.021 | ◯ | ◯ | Δ |
| 0.026 | Δ | Δ | X |
| 0.055 | X | X | X |

Key:
X Continuous film not formed.
Δ Weakly formed film.
◯ Good continuous film.

After the PUFS samples in Table D were allowed to dry, the samples demonstrating a “good continuous film” were manually coated with various polyurethane resin paints using a brush to form a film thereon. The polyurethane resins used were both water- and solvent-based paints available from Dai-ichi Kogyo Sieyaku Company, Ltd., Kyoto, Japan, and Mitsui Takeda Chemicals, Inc., Tokyo, Japan, respectively. The water-based polyurethane paints used from Dai-ichi Kogyo Sieyaku Company, Ltd. were SUPERFLEX® E-4500, SUPERFLEX® E-2000 and SUPERFLEX® E-2500. The paints used from Mitsui Chemical, Inc. were the solvent-based paints under the trade designations of Takenato D-101A, D-102, and D-103.

When applied to the PUFS positive samples set forth in Table D and allowed to dry at room temperature, a protective, self-supporting, continuous film was formed on the polyurethane foam substrate which strongly adhered to the substrate's surface. In addition, no deterioration of the foam substrate or penetration into its interior by the polyurethane paints was observed. Furthermore, the film layer formed on each of the PUFS samples was smooth and continuous, and possessed the degree of flexibility consistent with the resilient nature of the foam substrate as a result of the urethane bonding by chemical reaction between the —NCO group and the —OH group. Moreover, the PUFS coated with the SUPERFLEX E-2000 and E-2500 polyurethane paints were observed to possess the property of being water impermeable while simultaneously being permeable to water vapor.

### EXAMPLE 15

A 2% aqueous solution of sodium polycarboxylate was prepared by dissolving 2 grams of the sodium polycarboxylate powder in 1,000 ml. of water. The grade of sodium polycarboxylate used is available from Daicel Kagaku Kougyo Co., Ltd. of Japan, under the numerical designation 1105. The viscosity of the aqueous solution for application to a low density polyurethane foam substrate (density=0.016 kg/m³) was adjusted to 20 centipoise by the preparation of the 2% aqueous solution. After application with a brush, a single coat of a thin film was formed on the surface of the low density polyurethane foam substrate and allowed to dry at room temperature.

After drying, a single coating of a polyurethane resin paint was manually applied to the treated substrate using a brush to form a thin film thereon. The polyurethane resin used was a water-based paint available from Dai-ichi Kogyo Sieyaku Company, Ltd., Kyoto, Japan, under the trademark name of Superflex® E-4500.

After the resin paint's application, it was allowed to dry at room temperature. A protective, self-supporting, continuous film was formed on the treated low-density foam substrate which strongly adhered to the substrate's surface. In addition, no deterioration of the foam substrate or penetration into its interior by the Superflex® E-4500 polyurethane paint was observed. Furthermore, the film layer formed on the substrate was smooth and continuous, and possessed the degree of flexibility consistent with the resilient nature of the foam substrate as a result of the urethane bonding by chemical reaction between the —NCO group in the paint layer and the —OH group in the primary layer.

### EXAMPLES 16-18

As Example 16, a 5% aqueous Gum Arabic solution was prepared by dissolving 5 grams of Gum Arabic available from Miki Sangyo Company, Ltd. under the brand name “Sudan,” in 95 grams of water. The viscosity of the solution was determined to be 6 centipoise at room temperature using the Rion “Viscotester” apparatus, Model T-04.

As Example 17, a 10% aqueous Gum Arabic solution was prepared in the manner described in Example 15 by dissolving 10 grams of the same Gum Arabic in 90 grams of water. The viscosity of the solution was determined to be 20 cps.

For Example 18, a 20% aqueous Gum Arabic solution was prepared by dissolving 20 grams of the Gum Arabic in 80 grams of water. The viscosity of the solution was determined to be 50 cps.

One coating of each of the Gum Arabic solutions of Examples 16-18 were manually applied with a brush to the surface of polyurethane foam substrates whose densities are identical to those set forth in Table A. Thereafter, the PUFS samples were allowed to dry at room temperature. The result of the prepared PUFS samples are presented in Table E.

TABLE E

| PUFS | | | |
|---|---|---|---|
| Density | Example 16 | Example 17 | Example 18 |
| (kg/m³) | (6 cps) | (20 cps) | (50 cps) |
| 0.016 | Δ | ◯ | ◯ |
| 0.021 | ◯ | ◯ | ◯ |
| 0.026 | ◯ | ◯ | ◯ |
| 0.055 | ◯ | ◯ | ◯ |

Key:
X Continuous film not formed.
Δ Weakly formed film.
◯ Good continuous film.

With the exception of the sole PUFS sample that showed a “weakly formed film” on its surface, and after the PUFS samples in Table E were allowed to dry, they were manually coated with one coat of various polyurethane resin paints using a brush to form a film thereon. The polyurethane resins used were both water- and solvent-based paints available from Dai-ichi Kogyo Sieyaku Company, Ltd., Kyoto, Japan, and Mitsui Takeda Chemicals, Inc., Tokyo, Japan, respectively. The water-based polyurethane paints used from Dai-ichi Kogyo Sieyaku Company, Ltd. were SUPERFLEX® E-4500, SUPERFLEX® E-2000 and SUPERFLEX® E-2500. The paints used from Mitsui Chemical, Inc. were the solvent-based paints under the trade designations of Takenato D-101A, D-102, and D-103.

When applied to each of the PUFS samples set forth in Table E and allowed to dry at room temperature, a protective, self-supporting, continuous film was formed on the polyurethane foam substrate which strongly adhered to the substrate's surface. In addition, no deterioration of the foam substrate or penetration into its interior by the polyurethane paints was observed. Furthermore, the film layer formed on each of the PUFS samples was smooth and continuous, and possessed the degree of flexibility consistent with the resilient nature of the foam substrate as a result of the urethane bonding by chemical reaction between the —NCO group and the —OH group. Moreover, the PUFS coated with the SUPERFLEX E-2000 and E-2500 polyurethane paints were observed to possess the property of being water impermeable while simultaneously being permeable to water vapor.

The methods according to the invention, and the products produced thereby, as demonstrated by the foregoing examples, allow film-forming, protective urethane coatings to be applied to a porous polyurethane substrate without the deleterious effects of chemical attack or deterioration of the foam. At the same time, a protective film layer, which is consistent with the resilient nature of the foam, is provided that results in an effective durable seal for the foam substrate.

It will be appreciated that other equivalent materials and procedures may be used for accomplishing the advantages and improvements of the invention herein without departing from the true spirit and scope of the following claims.

1. A method for coating a porous polyurethane resin with an aromatic isocyanate coating composition comprising the steps of:
(a) providing a porous polyurethane resin substrate comprising at least one surface upon which the coating composition is to be applied;
(b) applying one or more primary layers to said substrate surface, said primary layer comprising an aqueous solution of a compound that includes at least one —OH reactive group in its non-aqueous, dry state, which is capable, upon drying, of forming a self-supporting, continuous film on said substrate surface at room temperature;
(c) optionally subjecting the applied primary layer to forced drying conditions at a temperature below the softening point of said porous polyurethane resin; and
(d) after allowing the primary layer to substantially dry, applying a secondary layer to the primary layer, said secondary layer comprising an aromatic isocyanate compound containing one or more reactive —NCO groups for reaction with the —OH reactive group in the primary layer;
wherein a continuous, film-forming coating is formed on said substrate surface.

2. The method according to claim 1 wherein multiple coatings of the primary layer are applied to said substrate surface.

3. The method according to claim 1 wherein the primary layer comprises an aqueous solution of polyvinyl alcohol or polyvinyl alcohol/polyvinyl acetate copolymer, the polyvinyl acetate component of the copolymer being present in an amount of 1-14 weight percent.

4. The method according to claim 3 wherein the concentration of the polyvinyl alcohol or polyvinyl alcohol/polyvinyl acetate copolymer solution is about 0.5 to 5.0 percent by weight.

5. The method according to claim 1 wherein the primary layer comprises an aqueous solution of carboxymethylcellulose.

6. The method according to claim 5 wherein the concentration of the carboxymethylcellulose solution is about 1 to 3 percent by weight.

7. The method according to claim 5 wherein the concentration of the carboxymethylcellulose solution is about 1.8 to 2.2 percent by weight.

8. The method according to claim 1 wherein the primary layer comprises an aqueous solution of starch.

9. The method according to claim 8 wherein the concentration of the starch solution is about 1 to 8 percent by weight.

10. The method according to claim 9 wherein the concentration of the starch solution is about 3 to 5 percent by weight.

11. The method according to claim 1 wherein the primary layer comprises an aqueous solution of sodium or ammonium polyacrylate.

12. The method according to claim 11 wherein the concentration of the sodium or ammonium polyacrylate solution is about 10 to 51 percent by weight and the sodium or ammonium polyacrylate has a molecular weight range of about 2,000 to 6,000.

13. The method according to claim 12 wherein the concentration of the sodium or ammonium polyacrylate solution is about 20 to 41 percent by weight.

14. The method according to claim 1 wherein the primary layer comprises an aqueous solution of polyacrylic acid.

15. The method according to claim 14 wherein the concentration of the polyacrylic acid solution is about 10 to 41 percent by weight and the polyacrylic acid has a molecular weight range of about 2,000 to 6,000.

16. The method according to claim 15 wherein the concentration of the polyacrylic acid solution is about 20 to 41 percent by weight.

17. The method according to claim 1 wherein the primary layer comprises an aqueous solution of sodium polycarboxylate.

18. The method according to claim 17 wherein the concentration of the sodium polycarboxylate solution is about 10 to 41 percent by weight and the sodium polycarboxylate has a molecular weight range of about 2,000 to 170,000.

19. The method according to claim 18 wherein the concentration of the sodium polycarboxylate solution is about 20 to 41 percent by weight.

20. The method according to claim 1 wherein the primary layer comprises an aqueous solution of an alkyl acrylate or alkyl methacrylate compound.

21. The method according to claim 20 wherein the concentration of the alkyl acrylate or alkyl methacrylate solution is about 5 to 40 percent by weight and the alkyl acrylate or alkyl methacrylate has a molecular weight range of about 5,000 to 10,000.

22. The method according to claim 21 wherein the concentration of the alkyl acrylate or alkyl methacrylate solution is about 10 to 20 percent by weight.

23. The method according to claim 1 wherein the primary layer comprises an aqueous solution of gum arabic.

24. The method according to claim 23 wherein the concentration of the gum arabic solution is about 5 to 40 percent by weight.

25. The method according to claim 1 wherein the aromatic isocyanate coating composition is in the form of a water-based, polyurethane paint.

26. The method according to claim 1 wherein the aromatic isocyanate coating composition is in the form of a solvent-based, polyurethane paint.

27. The method according to claim 1 wherein the porous polyurethane resin has a density in the range of about 0.002 to 1.000 kilograms per cubic meter.

28. A method for preparing a reactive film-forming surface on a porous polyurethane substrate for bonding with a coating composition comprising an aromatic isocyanate compound, comprising the steps of
(a) providing a porous polyurethane substrate comprising a density of from about 0.002 to about 1.000 kilograms/cubic meter and at least one surface for preparing the reactive film-forming surface thereon;
(b) applying to the surface of the porous polyurethane substrate, at least one layer comprising an aqueous solution of a compound that includes at least one —OH reactive group in its non-aqueous, dry state, said layer being capable, upon drying, of forming a self-supporting, continuous film on said substrate surface at room temperature; and
(c) optionally subjecting the layer to forced drying conditions at a temperature below the softening temperature of the substrate.

29. The method according to claim 28 wherein more than one layer of the aqueous solution is applied to said substrate surface.

30. The method according to claim 28 wherein the layer comprises an aqueous solution of polyvinyl alcohol or polyvinyl alcohol/polyvinyl acetate copolymer, the polyvinyl acetate component of the copolymer being present in an amount of 1-14 weight percent.

31. The method according to claim 30 wherein the aqueous concentration of the polyvinyl alcohol or polyvinyl alcohol/polyvinyl acetate copolymer is about 0.5 to 5.0 percent by weight.

32. The method according to claim 28 wherein the layer comprises an aqueous solution of carboxymethylcellulose.

33. The method according to claim 32 wherein the aqueous concentration of the carboxymethylcellulose solution is about 1 to 3 percent by weight.

34. The method according to claim 32 wherein the aqueous concentration of the carboxymethylcellulose solution is about 1.8 to 2.2 percent by weight.

35. The method according to claim 28 wherein the layer comprises an aqueous solution of starch.

36. The method according to claim 35 wherein the aqueous concentration of the starch solution is about 1 to 8 percent by weight.

37. The method according to claim 35 wherein the aqueous concentration of the starch solution is about 3 to 5 percent by weight.

38. The method according to claim 28 wherein the layer comprises an aqueous solution of sodium or ammonium polyacrylate.

39. The method according to claim 38 wherein the concentration of the sodium or ammonium polyacrylate solution is about 105 to 51 percent by weight and the molecular weight range of the sodium or ammonium polyacrylate is about 2,000 to 10,000.

40. The method according to claim 39 wherein the concentration of the sodium or ammonium polyacrylate solution is about 20 to 41 percent by weight.

41. The method according to claim 28 wherein the layer comprises an aqueous solution of polyacrylic acid.

42. The method according to claim 41 wherein the concentration of the polyacrylic acid solution is about 5 to 41 percent by weight and the molecular weight range of the polyacrylic acid is about 2,000 to 170,000.

43. The method according to claim 42 wherein the concentration of the polyacrylic acid is about 20 to 41 percent by weight.

44. The method according to claim 28 wherein the layer comprises an aqueous solution of sodium polycarboxylate.

45. The method according to claim 44 wherein the concentration of the sodium polycarboxylate solution is about 10 to 41 percent by weight and the molecular weight range of the sodium polycarboxylate is about 2,000 to 170,000.

46. The method according to claim 45 wherein the concentration of the sodium polycarboxylate solution is about 20 to 41 percent by weight.

47. The method according to claim 28 wherein the layer comprises an aqueous solution of an alkyl acrylate or alkyl methacrylate compound.

48. The method according to claim 47 wherein the concentration of the alkyl acrylate or alkyl methacyrlate solution is about 5 to 40 percent by weight and the molecular weight range of the alkyl acrylate or alkyl methacrylate compound is about 5,000 to 10,000.

49. The method according to claim 48 wherein the concentration of the alkyl acrylate or alkyl methacyrlate solution is about 10 to 20 percent by weight.

50. The method according to claim 28 wherein the layer comprises an aqueous solution of gum arabic.

51. The method according to claim 50 wherein the concentration of the gum arabic solution is about 5 to 40 percent by weight.

52-101. (canceled)

102. The method according to claim 1 wherein the aromatic isocyanate compound is 4,4′-diphenyl-methane diisocyanate.

103. The method according to claim 1 wherein the aromatic isocyanate compound is hexamethylene diisocyanate.

104. The method according to claim 1 wherein the aromatic isocyanate compound is selected from the group consisting of 4,4′-diphenylmethane diisocyanate, 1,5-naphthalene diisocyanate, hexamethylene diisocyanate, toluene diisocyanate, 0-tolidine diisocyanate, xylylene disocyanate (XDI), hydro xylylene diisocyanate, and hydro 4,4′-diphenylmethane diisocyanate.

105. The method according to claim 1 wherein the secondary layer additionally comprises an anti-hydrolysis agent.

106. The method according to claim 105 wherein the anti-hydrolysis agent is a polycarbodiimide.

107. The method according to claim 1 wherein the secondary layer additionally comprises a weather-resistance agent.

108. The method according to claim 107 wherein the weather-resistance agent is {tetrakis [methylene-3-(3′5′-ditert-butyl-4′-hydroxylphenyl) propionate]methane}.

109. The method according to claims 1 or 28 wherein the drying conditions occur at a temperature in the range of from 50° C. to 60° C.

110. The method according to claims 1 or 28 wherein the respective primary layer and reactive film-forming layer comprises a compound selected from the group consisting of polyvinyl alcohol or polyvinyl alcohol/polyvinyl acetate copolymer, carboxymethylcellulose, starch, sodium or ammonium polyacrylate, polyacrylic acid, sodium polycarboxylate, a alkyl acrylate or alkyl methacrylate compound, and gum arabic.

111. The method according to claim 1 wherein the secondary layer is in the form of a water-based, polyurethane paint.

112. The method according to claim 1 wherein the secondary layer is in the form of a solvent-based, polyurethane paint.
